(19) United States
(12) Patent Application Publication
(10) Pub. No.: US 2019/0025231 A1
(43) Pub. Date: Jan. 24, 2019

(54) A METHOD OF DETECTION OF DEFECTS IN MATERIALS WITH INTERNAL DIRECTIONAL STRUCTURE AND A DEVICE FOR PERFORMANCE OF THE METHOD

(71) Applicant: ADVACAM S.R.O., Praha 7 (CZ)

(72) Inventors: Jan JAKUBEK, Hýskov (CZ); Josef UHER, Roznov pod Radhostem (CZ)

(21) Appl. No.: 15/757,655

(22) PCT Filed: Sep. 14, 2016
(86) PCT No.: PCT/CZ2016/000102

§ 371 Date: Mar. 6, 2018

(30) Foreign Application Priority Data
Sep. 15, 2015 (CZ) PV 2015-623

(51) Int. Cl. G01N 23/18; G01N 23/04

(52) U.S. Cl. CPC G01N 23/18; G01N 23/04

(57) ABSTRACT

Problem to be resolved: Non-destructive detection of directional and other defects in structured materials that cannot be detected by current detection and imaging methods.

Problem solution: The problem has been resolved by inclining the incident beam of ionizing radiation irradiating the examined object (3), while knowing the geometry of positions of the object (3), source (2) of beams ionizing radiation and detector (8), including the size of the angle of incidence (α). Based on detection of an attenuated or dispersed beam of ionizing radiation an image is obtained of directional defects in the material with internal structure.

### FIELD OF THE INVENTION

The invention deals with a method and a device performing non-destructive detection of defects in materials with internal directional structure, particularly in large objects made of materials with internal directional structure.

### BACKGROUND OF THE INVENTION

Non-destructive detection of defects in materials with internal directional structure is difficult or even impossible with common detection techniques. An example of materials with directional structure are composites which includes directionally arranged fibres embedded in a binder. It is necessary to perform non-destructive quality control of the whole material volume in finished products to avoid local cracks that might lead to the total destruction of the product when it is put into regular use. The inspection includes not only quality of material composition, structural integrity and porosity but also a degree of undulation and directional arrangement of fibres in the material structure.

A common method of non-destructive testing of material with internal directional structure is based on ultrasound. Ultrasonic waves penetrating through the tested material are either locally absorbed or reflected depending on the material density and structure and thus it is possible to get information about the internal structure of an investigated object.

Another method exposes objects to X-rays and records changes in the radiation that passes through the examined sample/object. This method has been described for instance in the patent application U.S. Pat. No. 5,341,436 (A).

The above mentioned methods are generally capable of detecting abrupt changes in the structure/density of investigated object only, i.e. defects like missing material, impurities, cracks etc. However, changes just in the directional structure of the material cannot be captured by those methods because, as long as the fibres are distributed evenly in the binder, the resulting image is homogeneous. Thus, it is impossible to get information about the directional distribution of fibres in the binder, e.g. about the degree of undulation which affects service life and quality of the examined object when exposed to mechanical stresses. With some simplification, it could be concluded that images of an examined object with evenly arranged fibres in a piece of material of a defined thickness obtained by the known methods will look exactly the same as images of an object of the identical thickness with fibres concentrated in for instance to the first three quarters of material cross-section.

A method of non-destructive testing that detects the internal directional structure of materials is CT (computed tomography). CT allows obtaining a full 3D model of an investigated object. However, CT requires collection of an extensive set of images (projections) of the examined object from a plurality of angles. It means that collecting a sufficient data set for CT is generally very time-consuming and may not be even possible for objects significantly larger than the imaging devices used to collect projections. Hence, the method is inefficient for very large objects, such as windmill blades. Moreover, detecting arrangement of fibres in the binder requires a sufficient spatial resolution of the CT which on the other hand leads to reduction of the object size that could be investigated. This makes CT unpractical for large objects.

The objective of the invention is to create a method for detection of defects in materials with internal directional structure which will be able to detect mutual arrangement of fibres. in materials with internal directional structure. I.e. detecting their undulation. The method has to be fast and efficient enough that it can be used for large objects. The method has to be repeatable. It has to be easy to develop a device to conduct non-destructive testing using such method.

### SUMMARY OF THE INVENTION

The outlined objective has been resolved by creating a method based on radiation imaging system.

At least a part of the examined object, made of material with internal directional structure, is irradiated in a controlled manner with at least one beam of ionizing radiation within the method. The beam of ionizing radiation coming out of the examined object is detected with at least one detector. Subsequently, the quality of material with internal directional structure in the examined part of the object is analysed based on at least one detected difference between the incident beam of ionizing radiation that irradiated the object and the emergent beam of ionizing radiation that passed through the object.

The principle of the invention is based on a beam of ionizing radiation that reaches the examined object under an acute angle of incidence. Subsequently, the beam of ionizing radiation that passes through an area of anisotropic defect inside the object becomes unevenly attenuated and/or scattered. Then the altered emergent beam of ionizing radiation reaches a detector that generates at least one signal corresponding to the degree of attenuation and/or scattering of the beam of ionizing radiation as a result of the different trajectory through the material with directional internal structure. The signal is used to create a record of an anisotropic defect in internal directional structure of the object's material.

The intensity of interaction of ionizing radiation becomes sensitive to anisotropy of fibres inside the material structure by inclining the beam of radiation. Bundles of fibres undulating in the material are difficult to discern with beams impinging perpendicularly to the surface of an investigated object. However, if the object is irradiated under an acute angle the changes in attenuation/scattering of the ionizing radiation by variation in direction of fibres increase. Thus the method sensitivity to detect small variations in fibre direction increases allowing even small changes in the fibre direction to be detected.

In one preferred embodiment of the method for detection under this invention, there is the same part of an object irradiated with incident beams of ionizing radiation from at least two different directions. The recorded signals of detected beams of ionizing radiation are combined to accentuate anisotropy of the examined structured material. The method is also sensitive to defects not directly associated with arrangement of the fibres inside the material.

The same part of the object is irradiated with two inclined incident beams of ionizing radiation in a particularly preferred embodiment of the detection method under this invention. The beam angles of incidence are mirror-symmetric with respect to the normal line at the point of incidence. The recorded signals of detected beams of ionizing radiation are combined in order to analyse homogeneity and anisotropy of internal directional structure of the examined material. For homogeneous or isotropic samples both signal records obtained in this manner are identical. In case of materials with inhomogeneity or anisotropy the images are different. Defects in the material can be made visible by subtracting or adding of the two records. Anisotropy can be accentuated by subtraction and inhomogeneity by addition. Other convenient combinations of the signal records for analytical purposes include their multiplication.

In another preferred embodiment of the method under this invention, the records must be offset in respect to each other so that they can be added or subtracted, while the level of required offset indicates information about the depth of the signalized defect.

In another preferred embodiment of the method under this invention, the ionizing radiation consists of monochromatic or polychromatic X-rays. Monochromatic radiation is advantageous for structural analysis.

In another preferred embodiment of the method under this invention, the signal passes through at least one converter and it is transformed into a 2D colour record. Colours are convenient for better orientation in the resulting image of the internal structure.

In another preferred embodiment of the method under this invention, the ionizing radiation is modified with at least one device from the group of a collimator, filter and lens. Ionizing radiation spreads from the source in all directions and therefore it is desirable to direct the radiation and to adapt it for easier detection and subsequent analysis.

The invention also includes a device to perform methods for detection of defects in materials with internal directional structure.

The device for detection of defects in materials with internal directional structure includes at least one source of beam of ionizing radiation for irradiation of at least one part of an object made of material with internal directional structure, a holder of the object and at least one detector of beam of ionizing radiation.

The principle of the invention includes the fact that the source of beams of ionizing radiation and at least one detector form an adjustable set in which the source and at least one detector are arranged on a joint axis opposite to each other. Their joint axis passes through the object holder under an acute angle. The device allows mutual movement of the object and the source/detector set. The device is able to detect defects in large objects all along their length, without complicated resetting for each part of the examined long object. The device is able to detect anisotropic defects of fibres in the material and, thanks to that fact that the incident beam is perpendicular to the detector on the joint axis, it is also possible to detect porosity, cracks etc.

In a preferred embodiment of the device under this invention, the source is adapted to generate a flattened beam of ionizing radiation with an adjustable height. At least one set is provided with at least one shielded detector of a secondary beam of ionizing radiation placed away from the axis of the beam. A radiation opaque screen with a transparent area is situated between the shielded detector of the beam of ionizing radiation. The sample is irradiated with one or more beams under an acute angle of incidence and scattered radiation is detected. Intensity of the detected scattered radiation depends on orientation of structures inside the sample. The depth of a defect can be determined directly from the beam geometry, detection system and point of incidence of a diffuse photon on the detector. The system is complemented with detectors of transmitted primary radiation. Thus the method combines detection of anisotropy with a transmission method and detection of secondary radiation.

In another preferred embodiment of the device under this invention, the detectors include at least one hybrid semi-conductor pixel detector segment.

The method to detect defects in structured materials made up of organized fibres in a binder, including device to perform the method, are able to conveniently detect defects that cannot be detected by most currently known methods. The detection of structural defects is fast and efficient while the examined object can be of any shape or size. Arrangement of fibres inside the material can be shown without distortion by other defects and, at the same time, it is also possible to detect such other defects. Defects of different types can be highlighted with different colours in the resulting image.

### DESCRIPTION OF THE DRAWINGS

The described invention has been explained in more detail in the figures below where:

FIG. 1 shows a section of a structured material with undulating fibres that cannot be detected with perpendicular incident radiation beams,

FIG. 2 shows the changed trajectory of a beam of ionizing radiation under an acute angle of incidence,

FIG. 3 shows a procedure for signal treatment in order to detect anisotropic defects and inhomogeneity defects,

FIG. 4 shows a diagram of device configuration for detection of defects.

### EXAMPLES OF THE PREFERRED EMBODIMENTS OF THE INVENTION

It is understood that the below described and depicted particular cases of embodiment of the invention are presented for illustration and not to limit the invention to such examples. Those skilled in the art will find or will be able to provide, based on routine experimenting, one or more equivalents of the embodiments of the invention disclosed herein. Such equivalents shall be included into the scope of the following claims.

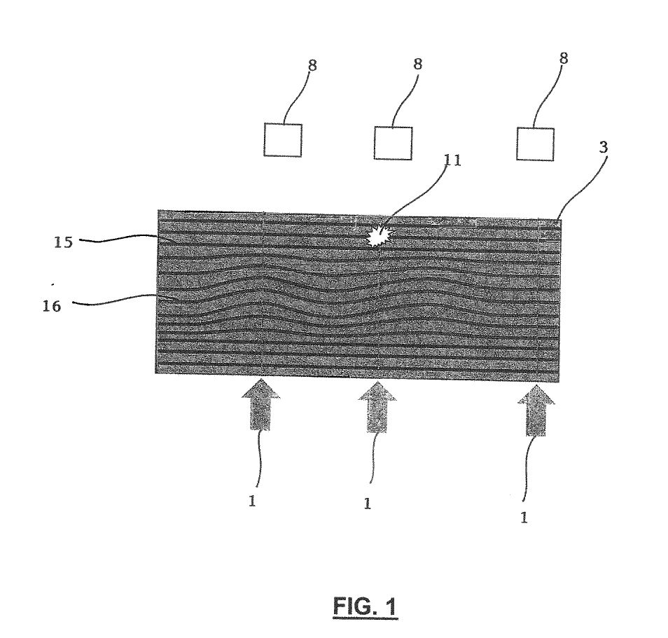

FIG. 1 shows the examined object 3 which demonstrates an organized internal structure.

The internal structure consists of non-undulating fibres 15 and undulating fibres 16. The object 3 also contains one defect 11 consisting of missing material. The sample is exposed to three beams 1 of ionizing radiation with the angle of incidence 0°, i.e. the beams are on the normal line not shown in the picture. The beams 1 pass through the object 3 and are detected by detectors 8 of ionizing radiation.

The lateral beams 1, due to their incident orientation, are unable to discern undulating fibres 16 from non-undulating ones 15, while the central beam 1 is able to detect the defect of missing material by means of the detector 8.

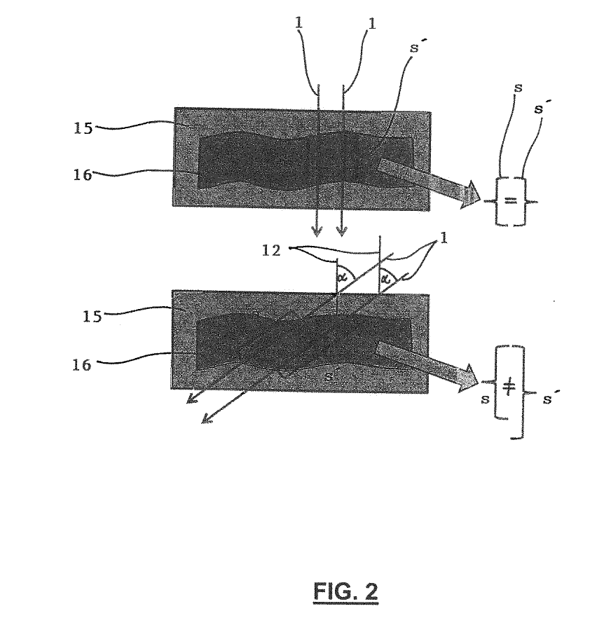

FIG. 2 shows a different situation in which beams 1 of ionizing radiation reach the object 3 made of material with directional internal structure under an acute angle of incidence α. Unlike beams 1 with the zero angle of incidence α, which have the same transmission trajectories s and s′ when passing through undulating fibres 16, beams with the angle α have different trajectories s and s′ when passing through the undulating fibres 16. This difference results in attenuation or scattering of the beam 1 and this difference in the parameters of the beam 1 coming out of the object 3 is detectable. The angle of incidence α is formed by the normal line at the point of incidence 12 and the beam 1 of ionizing radiation.

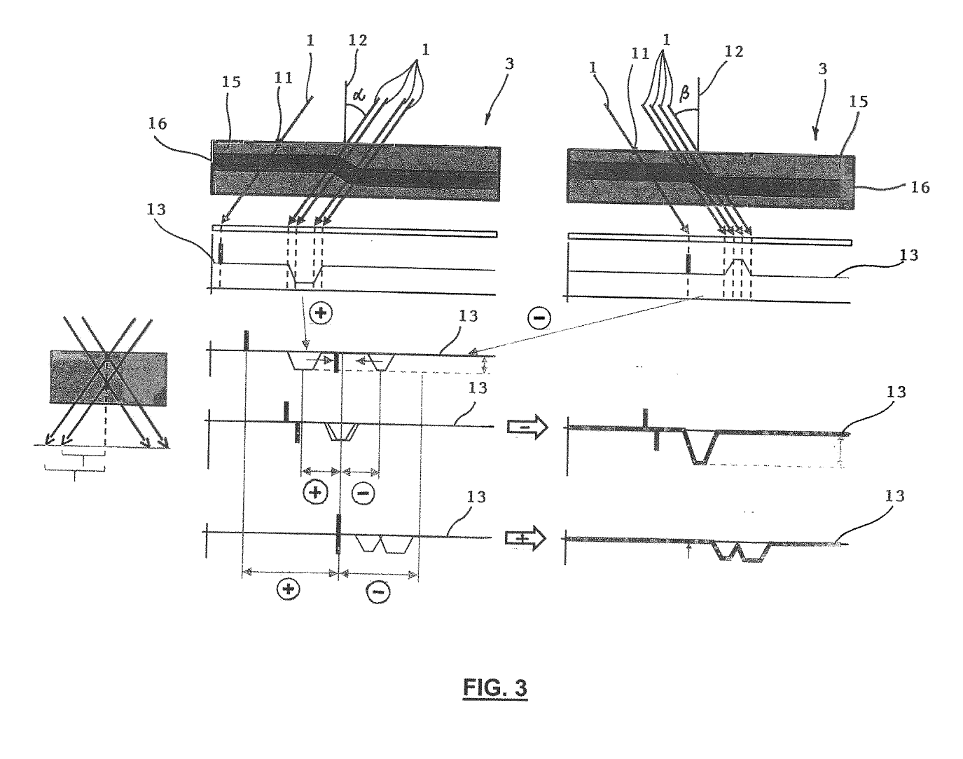

FIG. 3 shows a diagram of treatment of signal records 13. The records 13 are shown as images. Two records 13 are made for the same region of the object 3 which differ from each other due to the different angles of incidence α of the beam 1 of ionizing radiation. FIG. 3 shows a case in which the angles of incidence α and β for two exposures are axially symmetric to the normal line 12.

In case of exposure to the beam 1 under the angle of incidence α the beam 1 passes through undulating fibres 16 on a short path, which results in a reduced value of the signal recorded 13. In case of exposure to the beam 1 under the angle of incidence β the beam 1 passes through undulating fibres 16 on a longer path which results in a higher value of the signal record 13. The inhomogeneity defect 11 is equally visible in the signal records 13 for both the exposure directions.

To analyse the records 13 it is important to determine which defects 11 are supposed to be located. If you seek to detect defects of anisotropy 11 then the records 13 must be subtracted. Their difference provides information about the undulating fibres 16. If you seek to detect inhomogeneity defects 11 then the signal records must be added.

In order to perform the addition/subtraction the records 13 must be placed one over the other. The offset of the records 13 can be used to determine the depth of defect 11 in the material of the object 3 based on a trigonometric calculation. The information about the depth corresponds to the offset of the signal records 13.

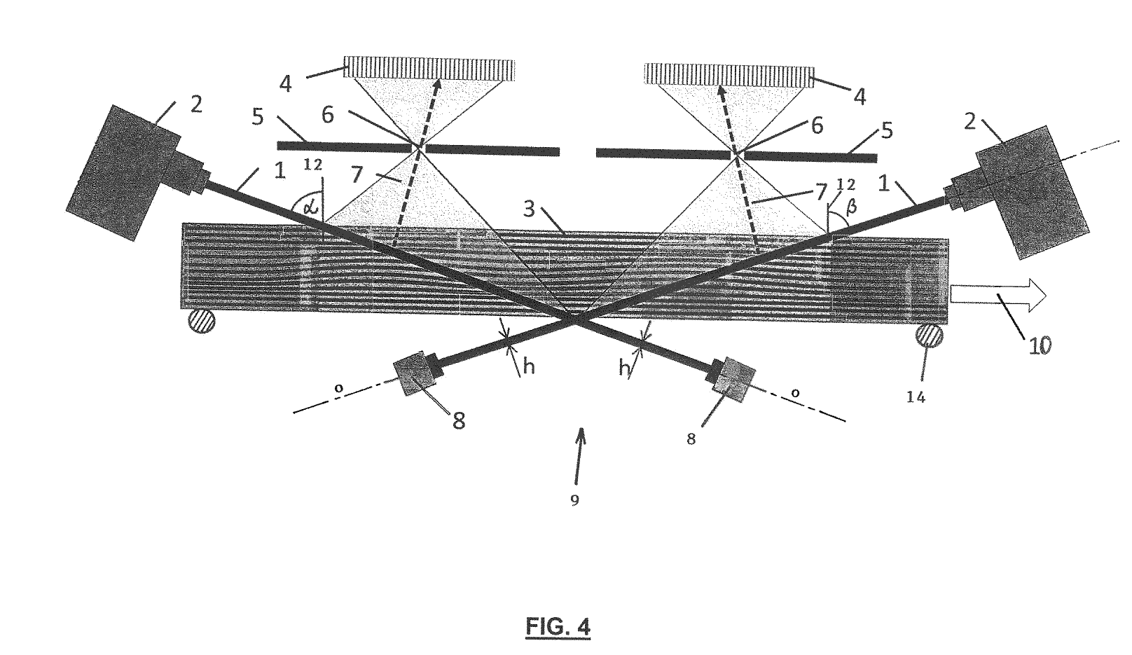

FIG. 4 shows a diagram of the device 9 for detection of defects 11 in materials with internal directional structure. The device 9 consists of a holder 14 of the object 3 that makes it possible to move the object 3 through the device 9 in the direction 10 or it holds the object 3 in a static position and the rest of the device 2 moves along the object 3. The device 2 includes two sets made up of a source 2 of beams of ionizing radiation 1 and a detector 8. The detector 8 is situated on a joint axis 2 with the source 2 on which beams of radiation 1 are spreading. The detector 8 is situated behind the object 3 and so the joint axis o passes through the object 3. The joint axis 2 and the normal line 12 form the angles of incidence α and β the size of which can be set up by positioning of the sets. Each set contains a shielded detector 4 which detects secondary and scattered beams of radiation 7 from the flattened beam of ionizing radiation 1. An opaque screen 5 with a transparent area 6 is situated between the shielded detector 4 and the object 3. Positions of the detectors 4 and 8, screens 5 with transmission areas 6 and sources of radiation 2 in respect to the object 3, including height h of the flattened beam 1 of ionizing radiation, are known for the purposes of mathematical calculations.

The sources 2 of beams 1 emit monochromatic or polychromatic X-rays modulated by means of a collimator and lenses inside the radiation source. The detectors 4 and 8 are made up of e.g. hybrid semi-conductor pixel detector segments. Generally known representatives of such segments are e.g. TimePix chips.

### INDUSTRIAL APPLICABILITY

The method for detection of defects in structured materials and the device for performance of the method under this invention can be applied e.g. in the aviation industry to make aircraft parts from composite materials or in manufacturing of ventilator and windmill blades.

### OVERVIEW OF THE POSITIONS USED IN THE DRAWINGS

1 beam of ionizing radiation
2 source of beams of ionizing radiation
3 examined object
4 shielded detector of secondary beams of ionizing radiation
5 screen
6 transparent area
7 secondary beam of ionizing radiation
8 detector of ionizing radiation
9 device for detection of defects in materials with internal structure
10 direction of sample movement
11 defect in material with internal structure
12 normal line at the point of incidence
13 detector signal record
14 object holder
15 non-undulating fibres
16 undulating fibres
o joint axis
h height of a beam of ionizing radiation
s transit trajectory
α first angle of incidence
β second angle of incidence

1. A method for detection of defects (11) in materials with internal directional structure in which at least a part of the examined object (3) made of a material with internal directional structure is irradiated in a controlled manner with at least one beam of ionizing radiation and then a beam of ionizing radiation emergent from the examined object (3) is detected with at least one detector (8) and then, based on at least one difference between the incident beam of ionizing radiation that reaches the object (3) and the beam of ionizing radiation emergent from the object (3), the quality of the material with internal directional structure is analysed on the examined part of the object (3), characterized by that the beam of ionizing radiation which irradiates the examined object (3) forms an acute angle (α) between the incident beam (1) of ionizing radiation and the sample surface normal; the beam of ionizing radiation passes through the object (3) in the area of anisotropic defect of material with the oriented internal directional structure on a trajectory with a different length, the beam of ionizing radiation is unevenly attenuated and/or scattered and the modified beam of ionizing radiation emerging from the object (3) reaches the detector (8); the detector (8) generates at least one signal corresponding to the degree of attenuation and/or scattering of the beam of ionizing radiation due to the different trajectory through the oriented internal directional structure of the material, and subsequently, a record (13) is created of an anisotropic defect in the internal directional structure of material of the object (3).

2. A method according to the claim 1 characterized by that the same part of the object (3) is irradiated with beams of ionizing radiation from at least two different directions and then records of signals (13) of detected beams of ionizing radiation are combined to analyse homogeneity and anisotropy of internal directional structure of the material.

3. A method according to claim 1 characterized by that the same part of the object (3) is irradiated with two inclined incident beams of ionizing radiation, while their angles of incidence (α, β) are mirror-symmetric with respect to the normal of the object surface and the signal records (13) of detected beams of ionizing radiation are combined to analyse homogeneity and anisotropy of internal directional structure of the material.

4. A method according to claim 2 characterized by that signal records (13) for analysis of homogeneity and anisotropy of internal directional structure of the material are combined while using at least one operation from the group of subtraction, addition and multiplication.

5. A method according to claim 4 characterized by that at least two signal records (13) for the same defect (11) are subtracted to identify anisotropic defects and at least two signal records (13) for the same defect (11) are added to identify inhomogeneity defects.

6. A method according to claim 5 characterized by that after addition or subtraction the signal records (13) are placed one over the other and the shift indicated by the overlapping records is used to calculate depth of the detected defect.

7. A method according to claim 1 characterized by that the beam of ionizing radiation consists of monochromatic or polychromatic X-rays.

8. A method according to claim 1 characterized by that the signal is transformed by at least one converter into a 2D colour image record (13).

9. A method according to claim 1 characterized by that the beam of ionizing radiation is modified with at least one device from the group of a collimator, filter and lens.

10. A device (9) for detection of defects (11) in materials with internal directional structure which consists of at least one source (2) of beams of ionizing radiation for irradiation of at least one part of the object (3) made of material with internal directional structure, a holder (14) of the object (3) and at least one detector (8) of beams of ionizing radiation characterized by that the source (2) of beams of ionizing radiation and at least one detector (8) form an adjustable set in which the source (2) and at least one detector (8) are situated on a joint axis (o) opposite to each other, the axis (o) passes through the holder (14) of the object (3) and forms an acute angle (α) with the normal of the incident beam of ionizing radiation, while at least one set and the holder (14) of the object (3) are installed to enable mutual movement.

11. A device according to claim 10 characterized by that the source (2) is adapted to generate flattened beams of ionizing radiation of fixed or adjustable height, at least one set is provided with at least one shielded detector (4) of secondary beams of ionizing radiation, which is situated outside the joint axis of the set, and a screen (5) with a transparent area (6) is situated between the shielded detector (4) of secondary beams of ionizing radiation and the axis of the set.

12. A device according to claim 11 characterized by that the detectors (4, 8) are made up of at least one hybrid semi-conductor pixel detector segment.
